(19) United States
(12) Patent Application Publication
(10) Pub. No.: US 2017/0349757 A1
(43) Pub. Date: Dec. 7, 2017

(54) CONTINUOUS FLOW PROCESS FOR MANUFACTURING SURFACE MODIFIED METAL OXIDE NANOPARTICLES BY SUPERCRITICAL SOLVOTHERMAL SYNTHESIS

(71) Applicants: ESSILOR INTERNATIONAL (COMPAGNIE GENERAL D'OPTIQUE), Charenton-le-Pont (FR); NIKON CORPORATION, Tokyo (JP); CENTRE NATIONAL DE LA RECHERCHE SCIENTIFIQUE - CNRS, Paris (FR)

(72) Inventors: Manuel THEODET, Tokyo (JP); Cyril AYMONIER, Paris Cedex 16 (FR)

(21) Appl. No.: 15/538,956

(22) PCT Filed: Dec. 23, 2014
(86) PCT No.: PCT/IB14/03129

§ 371 Date: Jun. 22, 2017

(51) Int. Cl. C09C 1/36; C09C 1/40; C09C 1/24; B01J 3/00; C09C 1/04; C01B 13/14; C09C 3/08; C09C 1/30

(52) U.S. Cl. CPC C09C 1/3669; C09C 3/08; C09C 1/407; C09C 1/3063; B01J 3/006; C09C 1/043; C01B 13/145; B01J 3/008; C09C 1/24

(57) ABSTRACT

The invention concerns a continuous flow process for manufacturing surface modified metal oxide nanoparticles by supercritical solvothermal synthesis in an reaction medium flowing within a continuous flow chamber, said continuous flow chamber containing a hydrolysis area and a supercritical area, said process comprising the introduction of a flow of metal oxide precursor into the continuous flow chamber at a point P located in the hydrolysis area or in the supercritical area, and the introduction of a flow of is located downstream of P1 with respect to the flow direction, as well as the device for carrying out this process.

### FIELD OF THE INVENTION

The present invention concerns a continuous flow process for manufacturing surface modified metal oxide nanoparticles by supercritical solvothermal synthesis, as well as the device for carrying out this method.

The process of the invention can be used for manufacturing complex nanoparticles such as hybrid organic-inorganic nanoparticles readily usable for making nanocomposite materials that may be in turn employed in various fields such as in optics, ceramics, catalysis, microelectronics, fuel cell technology, pharmaceutics or cosmetics.

### BACKGROUND OF THE INVENTION

Fine nanoparticles with a narrow particle size distribution may be produced with various methods, such as solid-state reaction, co-precipitation, sol-gel processes, hydrothermal and solvothermal synthesis, plasma chemical vapour deposition or combinations of these methods.

In nanotechnology, the hydrothermal processing has an edge over the other conventional processes because it is simple, cost effective, energy saving, pollution free (since the reaction is carried out in a closed system), it allows a better control of the nucleation, a higher dispersion, a higher rate of reaction and a better shape control. The solvothermal synthesis is very similar to the hydrothermal synthesis, the only difference being that the solvent used to facilitate the interaction of precursors during synthesis is not aqueous.

The supercritical hydrothermal method is an extension of hydrothermal technology. The difference between the conventional hydrothermal and supercritical hydrothermal technology is that hydrothermal is performed under mild conditions, whereas the supercritical hydrothermal technology deals with the reactions at temperatures just near or above the critical temperature. Under supercritical conditions, the nucleation and crystal growth of inorganic compounds in the hydrothermal reaction is promoted. As a result, rapid synthesis of inorganic nanoparticles, such as metal oxide nanoparticles can be achieved. Under supercritical hydrothermal conditions, nanometer size metal oxide particles can be synthetized and crystallinity of the nanoparticles is much higher when compared to the metal oxides obtained under conventional hydrothermal conditions, wherein bulk single crystals are formed.

Nanocomposite materials may be formed by direct mixing of the mineral nanoparticles with a polymer melt followed by extrusion (melt compounding), or by direct mixing of the mineral nanoparticles with a polymer solution followed by solvent evaporation (film casting), or by direct mixing of the mineral nanoparticles with a monomer solution followed by polymerization (in situ polymerization). However, mineral nanoparticles have a trend of spontaneous aggregation because of their large surface area versus volume ratio and high surface energy. Therefore, it may be difficult to obtain a homogeneous dispersion if there is a weak interfacial interaction between the nanoparticles and the monomer/polymer matrix.

To overcome this problem, the surface of the nanoparticles may be modified by adsorbing surfactants or by grafting adequate functional groups on the particle surface to obtain stable dispersions.

The surface modification of metal oxide nanoparticles may be performed by using supercritical hydrothermal synthesis in batch reactors.

For instance, Mousavand et al. (2007) reports a one-pot synthesis of surface-modified TiO2 nanoparticles in supercritical water. The supercritical hydrothermal synthesis is performed in the presence of the surface modifier (hexaldehyde) which is added to the batch reactor together with the metal salt. The supercritical hydrothermal synthesis leads to the chemical binding of hexaldehyde to the surface of the nanoparticles. This in situ surface modification implies more efficient immobilization of hexaldehyde on the TiO2 nanoparticles than when hexaldehyde is reacted with a TiO2 colloidal solution (post surface modification).

However, the in situ surface modification during the hydrothermal synthesis in batch reactors has several drawbacks. First, it does not allow control of size distribution of the nanoparticles. Furthermore, due to reaction kinetics and steric hindrance, the density of surface modifiers grafted onto the surface of the nanoparticles is difficult to control. This is all the more true when two or more surface modifiers are added to the batch reactor. In that case, the relative amount of surface modifiers grafted onto the surface of the nanoparticles is also difficult to control. Moreover, a batch reactor is limited in volume and therefore the volume of nanoparticles produced in a batch reactor is limited.

The prior art discloses in situ surface modification during supercritical hydrothermal synthesis in continuous mode wherein the surface modifiers and metal precursor are introduced into the continuous chamber at the same injection point. However, this process does not allow control of the size distribution of the nanoparticles or control of the way the nanoparticles are functionalized.

Therefore, there is a need to develop a process for preparing surface modified metal oxide nanoparticles that can allow control of size distribution of the nanoparticles as well as control of the way the nanoparticles are functionalized, especially when one or several surface modifiers are grafted to the surface of the nanoparticles.

### SUMMARY OF THE INVENTION

The present invention relates to a process for preparing surface modified metal oxide nanoparticles, such as hybrid organic-inorganic nanoparticles.

The process of the invention is performed in one-step by using supercritical solvothermal synthesis and in situ surface modification.

The process of the invention is a continuous flow process performed in a multi-injection continuous flow heated chamber.

According to the invention, surface modified metal oxide nanoparticles are formed by supercritical solvothermal synthesis in a reaction medium flowing within the continuous flow chamber. The starting materials, namely a metal oxide precursor and a surface modifier, are introduced into the continuous flow heated chamber preferably as pressurized flows in solution in a solvent.

The continuous flow chamber is preferably a tube reactor.

The process of the invention is performed at a temperature above the room temperature and at a pressure P greater than atmospheric pressure.

According to the invention, the heated continuous flow chamber includes two areas:
a hydrolysis area where the reaction medium (aqueous or not aqueous) is not in supercritical state and conditions are such that nucleation and growth of metal oxide nanoparticles can be initiated;
a supercritical area where the reaction medium is in supercritical state and the supercritical solvothermal synthesis of metal oxide nanoparticles can be performed. The supercritical area is downstream of the hydrolysis area with respect to the flow direction.

The introduction of the surface modifier into the heated continuous flow chamber allows surface modification of the nanoparticles by grafting the surface modifier onto the surface of the nanoparticles.

In a first aspect of the invention, the surface modifier is injected into the heated chamber after the solvothermal synthesis has started, i.e. after nucleation and growth of the desired nanoparticles has been initiated, thus at a point P2 which located in the hydrolysis area or in the supercritical area of the continuous flow chamber provided that P2 is downstream of the injection point of the metal oxide precursor (P1).

In contrast to the processes of the prior art, the metal salt and the surface modifier are not introduced into the continuous flow heated chamber at the same injection point of the continuous flow chamber but at different injection points. The injection point P1 of the metal oxide precursor and the injection point P2 of the surface modifier are thus separated by a certain distance with respect to the flow direction. The inventors have noted that the injection of the surface modifier within the continuous reaction chamber leads to stop or reduce the growth of the nanoparticle, thus, by having said distance, the nucleation and growth of oxide nanoparticles may start before the surface modifier is introduced. Further, by adjusting the distance between the injection point of the metal salt and the injection point of the surface modifier, one can control the reaction time of the synthesis of the metal oxide nanoparticles, hence the duration and conditions of nanoparticle growth, and thus the size of the obtained surface modified nanoparticles. On the other hand, the reaction time between the nanoparticle and the surface modifier and the amount of injected surface modifier are factors determining the amount of surface modifier grafted on the nanoparticle surface.

In a second aspect of the invention, one or several surface modifiers may be introduced into the heated chamber during the process for the purpose of surface modification of the desired nanoparticles. By introducing two or more surface modifiers at different point of injections, it is thus possible to graft different types of surface modifier, thereby leading to multi-functionalized nanoparticles. Furthermore, the order of introduction of the various surface modifiers enables to control the way the various surface modifiers are grafted onto the nanoparticles, as well as the relative amounts of the various surface modifiers grafted onto the nanoparticles. It is particularly advantageous when a surface modifier is less reactive than another one. A simultaneous introduction of various surface modifiers may lead to the actual grafting of only one surface modifier, i.e. the most reactive surface modifier. By contrast, a delayed introduction of the most reacting surface modifier gives sufficient time to the less reactive surface modifier to graft onto the nanoparticle.

Furthermore, in the case of one or several surface modifiers, a first surface modifier can be introduced within the chamber and grafted onto the surface of the nanoparticles and then a second modifier can be introduced which in turn grafts over the remaining free surface of the nanoparticles in competition with the first modifier. Thus, by adjusting the stoichiometry between the two surface modifiers, the relative amount of each surface modifier grafted to the surface of the nanoparticle can be controlled, which is not so easy when the surface modifiers are introduced simultaneously within the chamber.

In a third aspect of the invention, the process of the invention allows control of the size distribution of the nanoparticles by adjusting the type of flow, i.e. by choosing a turbulent flow or a laminar flow, or by adjusting the speed of the flow.

### DETAILED DESCRIPTION

It is a first object of the present invention to provide a continuous flow process for manufacturing surface modified metal oxide nanoparticles by supercritical solvothermal synthesis in a reaction medium (aqueous or non-aqueous) flowing within a continuous flow chamber, said continuous flow chamber containing two areas:
a hydrolysis area where the reaction medium is not in supercritical state and conditions are such that nucleation and growth of metal oxide nanoparticles can be initiated; and
a supercritical area where the reaction medium is in supercritical state and the supercritical solvothermal synthesis of metal oxide nanoparticles can be performed,
said process comprising the introduction of a flow of metal oxide precursor into the continuous flow chamber at a point P1 located in the hydrolysis area or in the supercritical area, and the introduction of a flow of surface modifier into the continuous flow chamber at a point P2 located in the hydrolysis area or in the supercritical area,
wherein P2 is located downstream of P1 with respect to the flow direction.

In one embodiment, the reaction medium is an aqueous reaction medium and the solvothermal synthesis is a hydrothermal synthesis.

The reaction medium (aqueous or non-aqueous) as used in the present specification is defined as the total flow within the heated chamber resulting from the introduction of the metal oxide precursor flow and the introduction of the surface modifier flow. Thus, the composition of the reaction medium need not be homogeneous along the continuous flow chamber and may vary depending on the location within the chamber in cases where the flow of surface modifier and/or the flow of metal oxide precursor comprise a solvent that is different from another solvent flowing through the chamber.

In the meaning of the invention, a reaction medium is considered to be an aqueous reaction medium if the solvent used in the medium contains 10 mol % water or more.

In one embodiment the aqueous reaction medium used in the present invention is water or a mixture of water and one or more alcohols, for example methanol, ethanol, isopropanol or butanol.

When the aqueous reaction medium is a mixture of water and alcohol, the molar ratio of water/alcohol, such as ethanol or isopropanol, can be from 1:5 to 5:2, in particular from 1:4 to 2:1, in particular from 2:3 to 1:1, in particular around 4:5.

Alternatively, while a preferred embodiment is related to processes and machines of the invention using an aqueous reaction medium under hydrothermal conditions, the processes and machines of the invention can be applied to solvothermal reactions for non-aqueous reaction medium, i.e. medium where the solvent contain less than 10% or even no water, provided that the solvent enables hydrolysis reactions of the metal oxide precursor in the solvothermal conditions.

Thus, in the following specification, unless a water content is explicitly cited, the term “reaction medium” is not limited to an aqueous reaction medium, and where the terms “hydrothermal” or “aqueous reaction medium” are used, the processes and machines can be adapted mutatis mutandis to a solvothermal process and a non-aqueous reaction medium respectively provided that the solvent enables hydrolysis reactions of the metal oxide precursor in solvothermal conditions.

Preferably, the reaction medium within the continuous flow heated chamber is a mixture of water with alcohol with a molar ratio of around 4:5, preferably a mixture isopropanol or ethanol with water with a molar ratio of around 4:5. Indeed, the use of this mixture allows the formation of metal oxide nanoparticles under supercritical conditions at a temperature lower than those required when using solely water as the reaction medium.

The flow of metal oxide precursor and the flow of surface modifier are pressurized at a pressure P which is above the atmospheric pressure so that to achieve the conditions allowing the supercritical hydrothermal synthesis within the continuous flow heated chamber. Typically, the flow may be pressurized by using a pump. In one embodiment, pressure P is from 10 MPa to 30 MPa, in particular from 15 MPa to 25 MPa, more particularly around 22 MPa.

In one embodiment, the continuous flow chamber is heated with an increasing gradient of temperature along the flow direction, ranging from at least T_{H} (the hydrolysis temperature at which nucleation and growth of metal oxide nanoparticles is initiated) and T_{C} (the temperature at which the reaction medium within the continuous flow heated chamber is in supercritical state).

Hence, the heated continuous flow chamber includes at least two areas:
a hydrolysis area wherein the temperature of the chamber is from T_{H} to T_{C};
a supercritical area wherein the temperature of the chamber is above T_{C}.

Within the hydrolysis area, the temperature of the reaction medium is above the hydrolysis temperature while under subcritical conditions, which allows initiating the nucleation and the growth of metal oxide particles. Then, the metal oxide particles go through the supercritical area. Under the supercritical conditions, the dissociation of the reaction medium is enhanced, which increases the hydrolysis of the metal salt and leads to the formation of nanosize metal oxide particles which are fully crystallized.

T_{H} depends on the composition of the reaction medium and is determined according to the nanoparticle size which is desired. In one embodiment, T_{H} is determined so as to obtain the lowest and the narrowest size distribution of nanoparticles. Typically, T_{H} is the temperature the most downstream between the two following conditions: the temperature reaches a temperature sufficient for allowing nucleation of nanoparticle, and the nanoparticle precursor is introduced in the continuous flow chamber.

In one embodiment, T_{H} is at least 100° C., in particular from 130° C. to 250° C., more particularly from 150° C. to 200° C.

T_{C} is the temperature at which the reaction medium within the continuous flow heated chamber is under supercritical state. T_{C} depends on the composition of the reaction medium and can be determined based on the phase diagram of the reaction medium.

In one embodiment, T_{C} is at least 240° C., in particular from 280° C. to 400° C., more particularly from 300° C. to 380° C.

The introduction of the surface modifier within the continuous flow heated chamber during the hydrothermal synthesis leads to the grafting of surface modifier onto the surface the metal oxide nanoparticles, thereby leading to the formation of surface modified metal oxide nanoparticles.

As explained previously, the flow of surface modifier is introduced within the continuous flow heated chamber at an injection point P2 which is different than P1 and which is downstream of P1, wherein P1 is the injection point of the metal oxide precursor.

Thus, in contrast to the processes of the prior art, the surface modifier is not introduced into the continuous flow heated chamber at the same injection point of the metal oxide precursor.

In this way, the surface modifier is introduced after nucleation and growth of the particles has started, which allows controlling the crystal arrangement, the size and the size distribution of the metal oxide nanoparticles. Conversely, if the metal salt and the surface modifier are injected at the same injection point, it may lead to the formation of smaller metal oxide nanoparticles with lower crystallinity and a higher size dispersion of the nanoparticles.

For a given relative amount of surface modifier and metal oxide precursor, the distance between P1 and P2 determines the amount of surface modifier grafted at the surface of the metal oxide nanoparticles as well as the size of the resulting surface modified metal oxide nanoparticles. In particular, the distance between P1 and P2 determines the duration of particle growth and nucleation un-disturbed by the presence of surface modifier, and it determines the duration of particle growth and nucleation happening simultaneously with grafting of the surface modifier. It may also impact the duration of supercritical growth and nucleation, without surface modifier and of supercritical simultaneous grafting and growth. Therefore, the distance between P1 and P2, as well as the respective amounts of metal oxide precursor and surface modifiers, determine the mean particle size, the size dispersion and the amount of surface modifier grafted at the surface of the metal oxide nanoparticles.

In one embodiment, P1 and P2 are both located in the hydrolysis area.

In another embodiment, P1 is located in the hydrolysis area and P2 is located in the supercritical area.

According to the process of the invention, the smaller the distance between P1 and P2, the smaller the size of the surface modified metal oxide nanoparticles. Therefore, one can control the size of the surface modified metal oxide nanoparticles by adjusting the distance between P1 and P2.

Furthermore, the smaller the distance between P1 and P2, the greater the amount of surface modifier grafted at the surface of the metal oxide nanoparticles. Therefore, one can control the amount of surface modifier grafted at the surface of the surface modified metal oxide nanoparticles by adjusting the distance between P1 and P2.

The multi-injection process of the invention also allows the grafting of different types of surface modifier on the nanoparticle, thereby leading to multi-functionalized nanoparticles.

The order of introduction of the various surface modifiers with respect to the flow direction enables to control the way the various surface modifier are grafted onto the nanoparticles as mentioned above.

Furthermore, the size distribution of the nanoparticles can be controlled by adjusting the type of flow, i.e. by choosing a turbulent flow or a laminar flow, a more turbulent flow leading to a narrower size distribution of the particles, by homogenization of the speed profile inside the chamber, or by adjusting the speed of the flow, the flow rate influencing the period of time during which the mixture is inside the chamber, thus influencing the time available for growth of the particle. An increased speed of the flow, or flow-rate, induces a reduced size of particles.

In one embodiment, the flow in the continuous flow heated chamber is a turbulent flow with a Reynolds number higher than 3000, in particular from 3000 to 8000.

A metal salt may be used as a precursor of the metal oxide nanoparticles.

In one embodiment, the metal salt is soluble in an aqueous reaction medium. For instance, it may be an inorganic acid salt such as a nitrate, a chloride, a sulfate, an oxyhydrochloride, a phosphate, a borate, a sulfite, a fluoride or an oxyacid salt of Cu, Ba, Ca, Zn, Al, Y, Si, Sn, Zr, Ti, Sb, V, Cr, Mn, Fe, Co or Ni, or an organic acid salt such as an alkoxide, a formate, an acetate, a citrate, an oxalate or a lactate of Cu, Ba, Ca, Zn, Al, Y, Si, Sn, Zr, Ti, Sb, V, Cr, Mn, Fe, Co or Ni. Mixtures of these metal salts may also be used.

In another embodiment, the precursor is non-soluble in an aqueous reaction medium. In that case, a non-aqueous reaction medium is used that enables hydrolysis of the precursor of the metal oxide nanoparticle in solvothermal conditions. Such couples precursor/non-aqueous solvent are well known by the person skilled in the art.

Preferably, the metal salt is a salt of titanium (IV) or zirconium, such as titanium (IV) isopropoxide, titanium (IV) propoxide, zirconium acetate, zirconium isopropoxide, zirconium propoxide or zirconium acetylacetonate.

The concentration of the metal oxide precursor in the reaction medium is not limited as long as it is dissolved in the reaction medium.

The concentration of the metal oxide precursor in the reaction medium may be from 0.0001 mol/l to 1 mol/l, in particular from 0.001 mol/l to 0.1 mol/l, more particularly from 0.01 mol/l to 0.1 mol/l. The concentration can be adjusted experimentally according to the desired size of the nanoparticles: the lower the concentration, the smaller the nanoparticles.

The surface modifier used in the present invention is any compound able to strongly interact with the surface of the nanoparticles to be treated. In one embodiment it is any compound capable of binding covalently with the nanoparticles surfaces. Alternatively, the surface modifier may be grafted to the surface of the nanoparticles by chemisorbtion or physisorbtion. The surface modifier has to be soluble in the reaction medium.

In one embodiment, the surface modifier is an organic ligand, thereby leading to hybrid organic-inorganic nanoparticles (functionalized nanoparticles).

In one particular embodiment, the organic ligand contains an acid group, such as a carboxylic acid group, a phosphonic acid group or a sulfonic acid group, a silane group, an amine group or a thiol group.

In a more particular embodiment, the organic ligand contains a carboxylic acid group, a phosphonic acid group or it may be an aldehyde. It may be for instance hexanoic acid, octylphosphonic acid, phenylphosphonic acid or phosphorous acid.

The amount of surface modifier injected into the continuous flow heated chamber is adjusted depending on the desired rate of functionalization of the nanoparticles.

Typically, the molar ratio of surface modifier/metal oxide precursor in the reaction medium is from 0.05 to 10, in particular from 0.1 to 1, more particularly from 0.15 to 0.2.

In order to perform a continuous process, the metal oxide precursor and the surface modifier are preferably both introduced into the heated chamber as flows in solution in a solvent which is miscible with the reaction medium. Furthermore, it is preferable that the metal oxide precursor and surface modifier be soluble in the reaction medium otherwise it may cause line, pump and filter clogging problems. Preferably, the reaction medium is an aqueous reaction medium.

The solvent of the flow of metal oxide precursor and the solvent of the flow of surface modifier may be identical or different. The composition and flow rate of each flow can be adjusted depending on the composition of the reaction medium desired within the heated chamber and depending on the relative amount of metal oxide precursor and surface modifier desired. Preferably, the solvent of the flow of metal oxide precursor and the solvent of the flow of surface modifier are water or a mixture of water and one or more alcohols, for example methanol, ethanol, isopropanol or butanol.

Typically, the metal oxide precursor and surface modifier are both injected into the continuous flow chamber from a stock solution having a given concentration of metal oxide precursor and surface modifier respectively. These flows may be combined with a flow devoid of both metal oxide precursor and surface modifier so as to obtain the desired concentrations of metal oxide and surface modifier in the reaction medium.

According to a principal embodiment of the process of the invention, a flow of surface modified metal oxide nanoparticles is recovered at the end of the supercritical area of the continuous flow heated chamber.

In one embodiment, the flow of surface modified metal oxide nanoparticles is quenched at a temperature below T_{H}, by using a cooling device, such as a condenser, which allows recovery of the surface modified metal oxide nanoparticles in the form of liquid suspension. The surface modified metal oxide nanoparticles can be recovered in dried form after filtering this suspension through a filter or after evaporating the solvent of the suspension.

The process of the present invention may be used for manufacturing surface modified metal oxide nanoparticles chosen from TiO2, ZrO2, ZnO, BaTiO3, NiMoO3, NiWO3, Al2O3, Ga2O3, In2O3, SiO2, GeO2, V2O5, CeO2, CoO, α-Fe2O3, γ-Fe2O3, NiO, Co3O4, Mn3O4, γ-MnO2, Cu2O, CoFe2O4, ZnFe2O4, ZnAl2O4, Fe2CoO4, BaZrO3, BaFe12O19, LiMnO2O4, LiCoO2 or La2O3.

As non-limited examples, TiO2 or ZrO2 particles may be functionalized with carboxylic acids or with phosphonic acids; BaTiO3 particles may be functionalized with silan groups (—Si(OR)3) or amines (—NH2); TiO2 or ZnO particles may be functionalized with thiol groups (—SH) or sulfonic acid (—SO2OH); NiMoO3 or NiWO3 particles may be functionalized with carboxylic acids.

In the following examples, the grafting operates by covalent bonding between the two or three oxygen atoms of the surface modifier with the oxide of the crystallite, thus surface modifiers with two or three oxygen atoms are preferred. But acid derivative of carboxylic acids (phosphonic, nitric, arsenic acids . . . etc) comprising at least a moiety with two or three oxygen atoms may also be used.

The size of the nanoparticles ranges is typically from 1 nm to 50 nm in diameter, in particular from 3 nm to 20 nm, for example between 5 nm and 10 nm. According to the process of the invention, the size of the surface modified metal oxide nanoparticles may be controlled by adjusting the distance between injection point P1 of the metal salt and the injection point P2 of the surface modifier.

Various crystalline structures of functionalized nanoparticles may be prepared with the process of the invention, depending on the type of metal oxide precursor and on the type of surface modifier, such as monocyclic and/or tetragonal structures.

Another object of the present invention is a device for carrying out the process of the invention, as described previously.

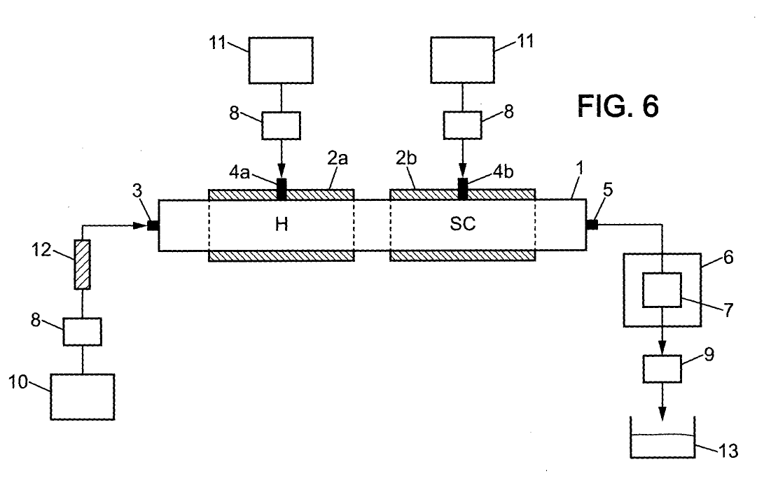

Referring to FIG. 6, the device of the invention comprises a continuous flow chamber (1) heated with a heater (2a, 2b) which heats the continuous flow chamber (1) with an increasing gradient of temperature along the flow direction.

The gradient of temperature defines at least two areas in the continuous flow heated chamber:
a hydrolysis area (H) where the reaction medium is not in supercritical state and conditions are such that nucleation and growth of metal oxide nanoparticles can be initiated and
a supercritical area (SC) where the reaction medium is in supercritical state and the supercritical solvothermal synthesis of metal oxide nanoparticles can be performed.

Moreover, the continuous flow chamber (1) has:
an inlet (3) for introducing the flow of metal oxide precursor into the continuous flow chamber (1) at an injection point P1,
one or several inlets (4a, 4b) for introducing the flow of surface modifier into said continuous flow heated chamber (1) within the hydrolysis area or within the supercritical area at an injection point P2 which is different than and downstream of P1.

The device may further comprise:
an outlet (5) for recovering the flow of surface modified metal oxide nanoparticles produced in the supercritical area,
a cooling device (6) connected to the outlet (5) followed by a filtering device (7) for recovering the surface modified metal oxide nanoparticles in dried form and a recipient (13) for recovering the solvent of the reaction medium, or followed by a container for recovering the surface modified metal oxide nanoparticles in the form of a suspension.

The continuous flow chamber (10) is preferably a tube reactor.

In one embodiment, the continuous flow heated chamber is composed of several modules connected in series. Each module is heated independently of each other with a heater, for instance a heating cartridge, which heats the module in a roughly uniform manner. The hydrolysis area may be covered by one or several modules. The supercritical area may be covered by one or several modules. The advantage of having several modules covering the hydrolysis area or the supercritical area is that the metal oxide precursor or the surface modifier may be injected between two modules. In this manner, the modules do not have to be equipped with injection inlets, which allows to use conventional continuous flow reactor of the prior art.

Thus, the inlets (4a, 4b) for introducing the pressurized flow of surface modifier into said continuous flow heated chamber (1) may be located between the modules.

In one embodiment, the continuous flow chamber (10) comprises in the flow direction two hydrolysis modules for performing the hydrothermal synthesis under subcritical conditions and two supercritical modules for performing the hydrothermal synthesis under critical conditions.

Alternatively, the continuous flow chamber may be composed of a single module which is heated by several heaters so as to obtain a gradient of temperature defining within the continuous flow chamber a hydrolysis area and a supercritical area.

The flow of metal oxide precursor and the flow of surface modifier may be injected into the continuous flow chamber respectively from stock solutions (10) and (11).

The flow of metal oxide precursor may be pre-heated before entering into the chamber (1) with a pre-heater (10).

The continuous flow chamber (1) is preferably made from stainless steel or Incorek. Its dimension is adjusted depending on the Reynolds number and the residence time desired. The residence time is the reaction time needed for growing the nanoparticle to the desired size.

Typically, the length of the tube may be from 1 m to 50 m, in particular from 3 m to 25 m, more particularly from 10 m to 15 m. The internal diameter may be from 0.5 mm to 100 mm, particularly from 1 mm to 10 mm, more particularly from 1.5 mm to 5 mm.

The flow of metal oxide precursor may be pressurized by using pumps (8), in particular high pressure pumps. The pumps may need to be high pressure pumps when they have to inject liquids in a system which is already pressurized.

The pressure of the chamber (1) may be controlled by using a back-pressure regulator (9).

For example, the solution may be pressurized by the combined effect of standard pumps injecting the fluid and a back pressure regulator which allows the fluid to pass through only when a pressure threshold is reached.

The temperature of the chamber (1) may be monitored by inserting thermocouples with a thermocouple probe inside the chamber (1) or by providing adequate controls to the heaters and monitoring the heaters parameters.

The invention will now be further described in the following examples. These examples are offered to illustrate the invention and should in no way be viewed as limiting the invention.

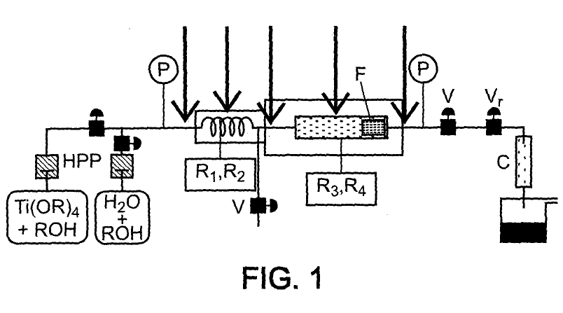

FIG. 1 shows a schematic diagram of the continuous flow reactor system according to the invention as used in Example 1.

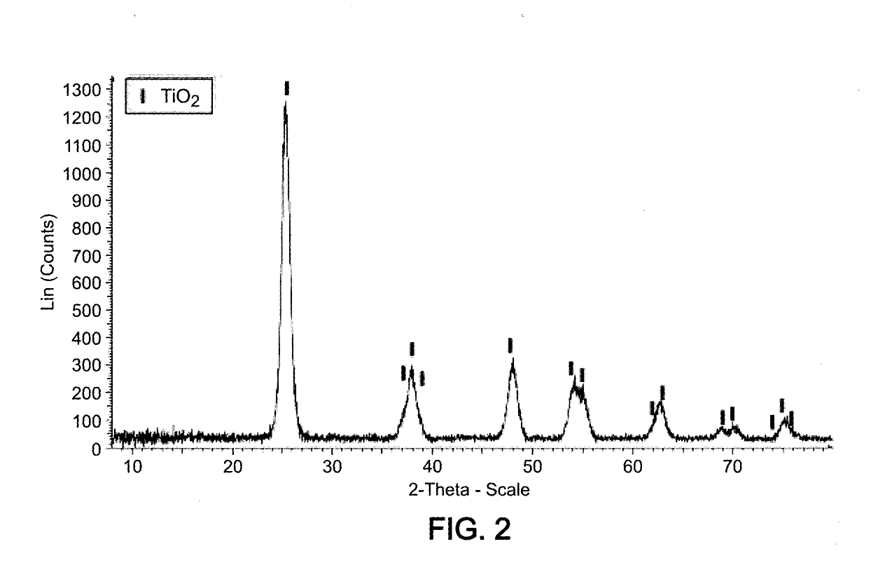

FIG. 2 represents the XRD pattern of TiO2 nanoparticles obtained by supercritical hydrothermal synthesis in a mixture of water and ethanol under supercritical conditions.

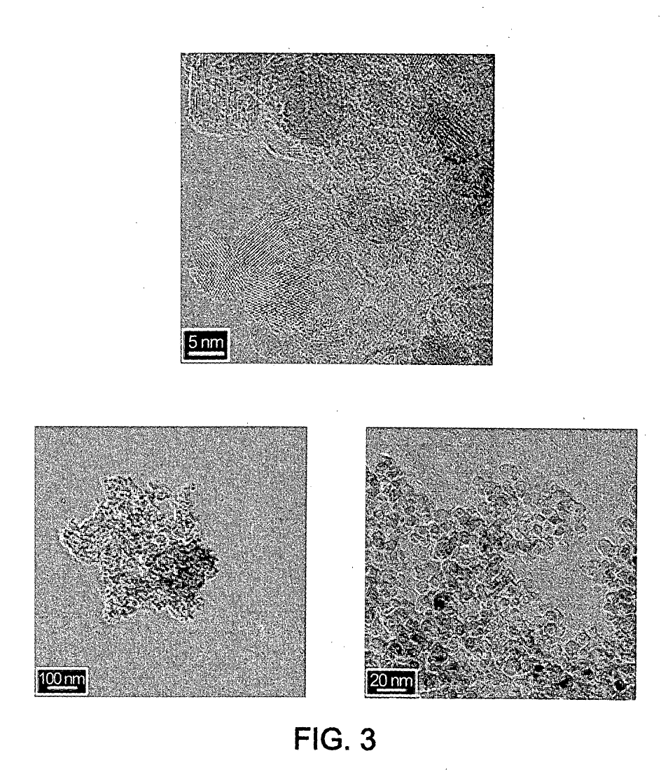

FIG. 3 represents the HR-TEM micrograph of TiO2 nanoparticles obtained by supercritical hydrothermal synthesis in a mixture of water and ethanol under supercritical conditions.

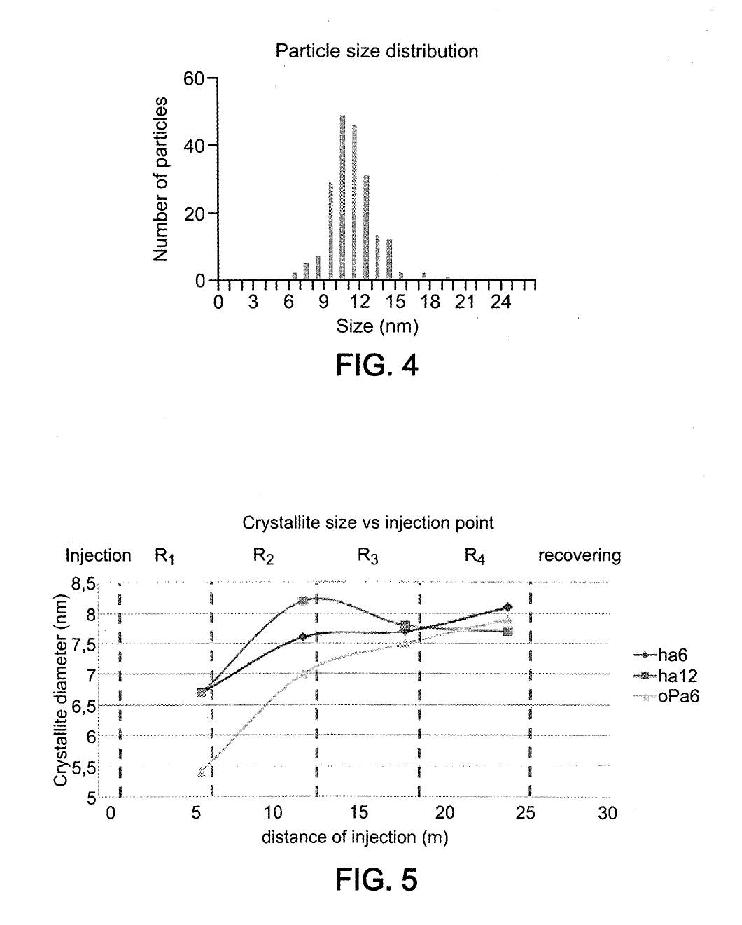

FIG. 4 represents the particle size distribution of the TiO2 nanoparticles obtained by supercritical hydrothermal synthesis in a mixture of water and ethanol under supercritical conditions.

FIG. 5 represents the particle size of surface modified TiO2 prepared with the process of the invention as a function of the injection point of the surface modifier.

FIG. 6 shows a schematic diagram of the continuous flow reactor system according to the invention.

### EXAMPLE 1: FUNCTIONALIZATION OF TIO₂ NANOPARTICLES

FIG. 1 shows a schematic diagram of the continuous flow reactor system.

ROH=ethanol
HPP=High pressure pump
P=Pressure gauge

### V=Valve

Vr=Regulation Valve, also called back-pressure regulator

### F=Filter

### C=Condenser

The system comprises four modules R1 to R4 connected in series. R1 and R2 are hydrolysis modules for performing the hydrothermal synthesis under subcritical conditions. R3 and R4 are supercritical modules for performing the hydrothermal synthesis under supercritical conditions.

The injection points of the surface modifier are positioned before the reactor R1, between the different modules (R1-R2, R2-R3, R3-R4) and after the reactor R4.

The supercritical hydrothermal synthesis of TiO₂ nanoparticles is performed with a mixture of water and ethanol (molar ratio water/ethanol=0.8) under the following conditions:
Titanium precursor: Ti(O-iC₃H₇)₄ in an aqueous solution with a Water/Ethanol molar ratio of 8, with a concentration in the stock solution=4.10⁻² mol·L⁻¹,
pressure P within R1-R4=22 MPa,
total flow Q within R1-R4=11.6 g·min⁻¹
Type of flow: turbulent (Re=3287),
R1 and R2:
   Tube reactor of stainless steel with a total length of 12 m, composed of two modules each with a length of 6 m,
   Temperature of 150° C.,
R3 and R4:
   Tube reactor of stainless steel with a total length of 12 m, composed of two modules each with a length of 6 m,
   Temperature of 380° C.

After the synthesis, TiO₂ nanoparticles (bare or functionalized) are recovered as solutions in water and ethanol. They are centrifuged and washed with ethanol 5 times to remove the unreacted surface modifier.

FIG. 2 represents the X-ray diffraction (XRD) pattern of the obtained TiO₂ nanoparticles without no addition of surface modifiers to the reaction system. It can be attributed to the ICDD-PDF card 00-021-1272 which corresponds to the body-centered tetragonal lattice (Anatase phase, space group I41/amd, a=3.785 Å, c=9.514 Å). From the Debye-Scherrer equation applied to peaks (101) at 25.326° and peak (200) at 48.1°, it is estimated that the mean size of crystallites is 7.3 nm.

FIG. 3 represents the HR-TEM micrograph (High Resolution Transmission Electron Microscopy) of the TiO2 nanoparticles. It shows their monocrystalline state. Thus it can be considered that the mean size of the crystallites is equivalent to the mean size of the particles. The estimation of particle size and particle size distribution was done from the counting of about 200 nanoparticles observed on TEM micrographs. Aggregated particles range from 6 nm to 15 nm. The maximum population has a size around 10 nm, and the mean size correlates with the one estimated with XRD.

FIG. 4 represents the particle size distribution of the TiO₂ nanoparticles.

The same experiment as above is performed but with addition of a surface modifier at various injections points of the system during the hydrothermal synthesis:
Between R1 and R2,
Between R2 and R3,
Between R3 and R4, or
After R4.

The injected surface modifier is either hexanoic acid (ha) or octylphosphonic acid (oPa). The molar ratio of Ti atoms injected per second to grafting heads of hexanoic acid molecules injected per seconds (Ti/ha ratio) is 6 (ha 6) or 12 (ha 12). The amount of injected surface modifier is adjusted in order to have a molar ratio of Ti atoms injected per second to grafting heads of phosphonic acid molecules injected per seconds (Ti/oPa) of 6 (oPa6) or 12 (oPa12). The surface modifier is in solution in a water-ethanol mixture, of the same composition and same water/alcohol molar ratio than the solvent of the titanium precursor.

The interaction of the functionalizing agents with the nanoparticles of TiO₂ is evidenced by evaluating its influence on the calculated crystallite size (regarded as the particle size).

Table 1 gives the average size of crystallites (calculated by Debye-Scherrer equation) depending on the injection point and on the molar ratio of surface modifier injected per Ti atoms in the precursor.

TABLE 1

| | | Size of the |
|---|---|---|
| Samples | Parameters observed | crystallites (nm ± 10%) |
| TI002 | Functionalization ex situ with DibuP | 8 |
| TI003 | Functionalization ex situ with Bis2P | 7.1 |
| TI004 | Functionalization ex situ with oPa | 7.7 |
| TI005 | Functionalization ex situ with 3oP | 7.5 |
| TI009 | Injection of ha6 after R₄ | 8.1 |
| TI010 | Injection of ha12 after R₄ | 7.7 |
| TI011 | Injection of oPa6 after R₄ | 7.9 |
| TI012 | Injection of ha6 between R₃ and R₄ | 7.7 |
| TI013 | Injection of ha12 between R₃ and R₄ | 7.8 |
| TI014 | Injection of oPa6 between R₃ and R₄ | 7.5 |
| TI015 | Injection of ha6 between R₂ and R₃ | 7.6 |
| TI016 | Injection of ha12 between R₂ and R₃ | 8.2 |
| TI017 | Injection of oPa6 between R₂ and R₃ | 7 |
| TI018 | Injection of ha6 between R₁ and R₂ | 6.7 |
| TI019 | Injection of ha12 between R₁ and R₂ | 6.7 |
| TI020 | Injection of oPa6 between R₁ and R₂ | 5.4 |

The lines TI002 to TI005 correspond to experiments where TiO2 nanoparticles are first synthesized as bare nanoparticles and the functionalization are performed in a second time, after the recovery of the nanoparticles in solution, as expressed by the use of the word “ex situ”.

FIG. 5 represents the crystallite size according to the injection point of the surface modifier. It clearly shows that the crystallite size decreases as the surface modifier is injected earlier in the synthesis process, especially with octylphosphonic acid. The earlier the injection of surface modifier, the smaller the crystallites. This is evidence of the interaction between the TiO₂ nanoparticles and the surface modifier, and that the grafted surface modifier impedes the growth of the nanoparticles. This also indicates that octylphosphonic acid seems to have a greater interaction with TiO₂ crystallites than hexanoic acid since its influence on crystallite size is stronger.

Furthermore, at least for hexanoic acid, a ratio of 1 grafting head of hexanoic acid molecule per 12 Ti atoms (Ti/ha ratio of 12) seems to not be enough to have an effective grafting on the crystallite without an hydrolysis step, as the size of the nanoparticles are unchanged if the hexanoic acid ha12 is injected after the hydrolysis step.

Furthermore, those results show that positioning the injection point so that the injection is done during the hydrolysis step of the process ensures a greater effect on the crystallite size.

FTIR (Fourier transform infrared spectroscopy) analyses performed for TiO₂ functionalized with octylphosphonic acid by injection of the surface modifier between R₂ and R₃ shows three bands corresponding to an alkyl chain [2960 cm⁻¹: vₐₛ(-CH₂—CH₃), 2925 cm⁻¹: vₐₛ(-CH₂—), 2850 cm⁻¹: vₛ(-CH₂—)], which is evidence of the presence of a functionalizing agent at the surface of TiO₂ nanoparticles. Moreover, the band at 1100-1000 cm⁻¹: vₛ(-P—O₃) is well visible, assessing the grafting of the modifier at the surface of the nanoparticles via the P—O functions. It can be concluded that from this injection point, TiO₂ nanoparticles are functionalized with octylphosphonic acid.

The same FITR analysis performed for TiO₂ functionalized with octylphosphonic acid by injection of the surface modifier between R₁ and R₂ shows the presence of an alkylene band at 1460 cm⁻¹: δ_{sc}(—CH₂—) and a stronger evidence of grafting with octylphosphonic acid at 1100-1000 cm⁻¹: vₛ(-P—O₃) than when the injection point is between R₂ and R₃.

TGA-MS (ThermoGravimetric Analyzer using a Mass Spectrometer) analysis carried out on the TiO₂ functionalized with octylphosphonic acid by injection of the surface modifier after R₄ show a mass loss higher than the bare nanoparticles: 7.5% against 2.9%. Moreover, the gas outputted by the loss is analyzed by the TGA-MS and is found attributable to organic fragments that correspond with octyl part of the octylphosphonic acid. Therefore, even though FTIR cannot pin-point the amount of functionalization, TGA-MS confirms that the TiO₂ particles obtained by injecting a oPa modifier are functionalized by octylphosphonic acid or one of its derivative, even when the injection point is situated after the supercritical tunnel (immediately after R4).

The same analysis for TiO₂ functionalized with octylphosphonic acid by injection of the surface modifier between R₃ and R₄ shows a 10% mass loss from which 7.1% can be attributed to organic parts which have a signal corresponding to the octyl part of the octylphosphonic acid.

The same analysis for TiO₂ functionalized with octylphosphonic acid by injection of the surface modifier between between R₁ and R₂ shows a mass loss of 20%, with only 2.9 corresponding to the bare particle, thus 17.1% can be attributed to organic parts which have a signal corresponding to the octyl chain of the phosphonic acid used.

It can be concluded that the continuous multi-injection process of the invention allows the in situ grafting of phosphonic acid molecules on TiO₂ crystallites in one step. Small and very well crystallized nanoparticles of TiO₂ are thus easy to obtain, especially by using a supercritical water/ethanol system. The position of the injection point of the surface modifier with respect to the flow direction has an influence on the amount of grafted surface modifier and on the size of the resulting nanoparticles. An early injection permits a higher functionalization and reduction of the crystallite size (and most probably the particle size too). However, the inventors have found that it is important to let the nucleation of the nanoparticles occurs before injecting the functionalizing surface modifier, otherwise the formation of TiO₂ crystallites is polluted by wastes. Indeed, in those cases, the resulting product has a very complex and poorly resolved XRD pattern. This means that part of the material seems to be amorphous. Further, the species produced are not pure TiO₂ particles functionalized by, for example, oPa chains, but probably particles of Ti—Oₓ—P_{y} materials. This is due to the high reactivity of P with metals, higher than O with metals and adding P modifier too early prevents TiO₂ from being formed.

### EXAMPLE 2: FUNCTIONALIZATION OF ZRO₂ NANOPARTICLES

The same system as the one used in Example 1 was used to prepare ZrO₂ crystallites with the same operating conditions.

### Reactants:

Zr precursor: zirconium acetylacetonate, zirconium acetate, zirconium propoxide or zirconium isopropoxide.

Surface modifiers: hexanoic acid, octylphosphonic acid, phenylphosphonic acid, phosphorous acid or SIK7709-10 (12-Dodecylphosphonic acid)triethylammonium bromide).

Solvent: water and ethanol or isopropanol.

In each case, the amount of injected surface modifier was adjusted to have a molar ratio acid molecule/zirconia of 0.16, which corresponds to the Ti/ha or Ti/P of 6 in the TiO₂ example.

After the synthesis, ZrO₂ nanoparticles (bare or functionalized) are recovered as solutions in water and ethanol or isopropanol. They are centrifuged and washed with ethanol 5 times to remove the unreacted surface modifier.

A peak corresponding to P—O-metal bound can be found on ZrO₂ crystallites under FTIR observation of the residue after the TGA analysis. Moreover, the associated Mass Spectroscopy of the gas emitted during the calcination at 1000° C. of the TGA analysis could not detect released fragments containing phosphorus.

These combined results mean that the phosphonic grafting heads, i.e. at least the phosphorous atoms, are still chemisorbed on the surface of ZrO₂ after TGA analysis at 1000° C. and they do not take part in the mass loss of the sample during TGA analysis.

It is to be noted that the same peak was observed for FTIR analysis of the residues of TiO₂ nanoparticles functionalized with oPa after the TGA analysis.

The results are provided in tables 2 and 3.

### M=Monoclinic

### T=Tetragonal

W/E=water/ethanol
W/iP=water/isopropanol
X means no dispersion in the medium of synthesis
Δ means acceptable but not so good dispersion
PA=Phosphorous acid
PPA=Phenylphosphonic acid

TABLE 2

| Medium | Water/Ethanol (molar ratio = 0.8) | | | | | | |
|---|---|---|---|---|---|---|---|
| Precursor | Zirconium acetylacetonate | | | | | | Zirconium |
| (molar ratio | | | | | | | propoxide |
| P/Zr = 0.16) | | | | | | | |
| Surface | Hexanoic | Octyl | Phosphorous | Phenylphosphonic acid | | | |
| modifier | acid | phosphonic | acid | | | | |
| | | acid | | | | | |
| Injection | Before R₁ | | | | Between | Between R₂ and R₃ | |
| point | | | | | R₁ and R₂ | | |
| Crystal | M | T | M/T | T | T | M | M/T |
| structure | | | | | | | |
| Size | no data | no data | no data | no data | 4 nm ± 2 | 7.5 nm ± 2 | 9 nm ± 4 |
| distribution | | | | | | | |
| Dispersion | X | X | X | X | X | X | X |

TABLE 3

| Medium | Water/Ethanol or Water/Isopropanol | | | | | Water | |
|---|---|---|---|---|---|---|---|
| | (molar ratio = 0.8) | | | | | | |
| Precursor | Zirconium propoxide or | | | Zirconium | Zirconium | Zirconium acetate | |
| (molar ratio | Zirconium isopropoxide | | | acetate | isopropoxide | | |
| P/Zr = 0.16) | | | | | | | |
| Surface | SIK7709-10 | | | | | PA then PPA | PPA then PA |
| modifier | | | | | | | |
| Injection | Between | Between R₂ and R₃ | | | Between | First modifier between R₁ and | |
| point | R₁ and | | | | R₃ and R₄ | R₂, then second modifier | |
| | R₂ | | | | | between R₂ and R₃ | |
| Crystal | M/T | M/T | M/T | M/T | M/T | M/T | M |
| structure | | | | | | | |
| Medium | W/iP | W/E | W/iP | W/E | W/iP | | |
| Size | 8.5 nm ± 4 | 8.5 nm ± 3 | 9 nm ± 3 | 6.5 nm ± 4 | 8.5 nm ± 4 | no data | no data |
| distribution | | | | | | | |
| Dispersion | Δ | Δ | Δ | Δ | Δ | Δ | X |

The results show that for ZrO₂ nanoparticles the structure of the functionalized nanoparticles depends on the nature of the surface modifier. Indeed, the XRD pattern is different whether hexanoic acid, octylphosphonic acid, phenylphosphonic acid or phosphorous acid is used.

With hexanoic acid, the monoclinic structure of the bare nanoparticles is maintained and with octylphosphonic acid the tetragonal structure of ZrO₂ is obtained. With these two surface modifiers, a well crystallized material is obtained, whereas with phosphorous acid and phenylphosphonic acid, the final material is poorly crystalline and it is difficult to distinguish clearly some phases, even though the mixture of crystallites of the monoclinic phase and crystallites of the tetragonal phase for the phosphorous acid and the presence of crystallites of the tetragonal phase for the phenylphosphonic acid can be guessed.

Surface modifier SIK7709-10 contains two active sites: a phosphonic acid moiety and an ammonium bromide moiety.

Experiments were done with a mixture of phenylphosphonic acid and of (1-butyl)triethylammonium bromide to simulate both active sites and see whether there will be a competition between the two moieties and which one will take the advantage.

The surface modifiers are solubilized together in a water/ethanol solution of molar ratio of 0.8 with a P/Zr and a N/Zr molar ratio of 0.16. Zirconium acetylacetonate was at a concentration of 4.10² mol·L⁻¹. Two injection points were tested: between R1 and R2 and between R2 and R3 with an injection flow of 10 mL·min⁻¹. The overall pressure is kept at 23 MPa. R1 and R2 were heated at 200° C. and R3 was heated at 380° C.

FTIR analysis of the obtained nanoparticles shows evidence of the presence of nitrogen containing compounds. Thus, it means that the phosphonic acid is preferentially grafted on the surface of the nanoparticles of ZrO₂ over the ammonium bromide.

A similar test was done in order to compare the relative reacting strength of phosphonic acid and carboxylic acid, i.e. which molecule will preferentially graft over the nanoparticles surface between the two surface modifiers considered.

It was evidenced that phosphonic acids is preferentially grafted over carboxylic acids or bromide. Therefore, the functionalization of a crystallite with bromide ending or with carboxylic acid functions can be performed respectively with a surface modifier comprising both a phosphonic acid function and a bromide and with a surface modifier comprising the carboxylic function.

Surface modifier SIK7709-10 can be used to graft a crystallite with ending bromide functions without grafting dangling phosphonic groups, which in turn would have the un-wanted effect of bridging particles one to each other, thus leading to strong aggregation of the nanoparticles.

The multi-injection setup was also used to inject separately in the chamber at a distance from each other two modifiers, namely phenylphosphonic acid and phosphorous acid. The injection points were respectively situated between R1 and R2 for the first modifier and between R2 and R3 for the second one. The surface modifiers were both solubilized in water with a P/Zr molar ratio of 0.08 each (as opposed to a ratio P/Zr of 0.16 for single-modifier experiments).

The precursor used was zirconium acetate, dissolved in water at a concentration of 4.10² mol·L⁻¹.

The separate injection of two different modifiers effectively leads to nanoparticles doubly grafted. The use of phenylphosphonic acid as a first surface modifier allows obtaining a doubly functionalized crystallite which has a mono-crystalline structure essentially composed of monoclinic crystals, while the use of phosphorous acid as first surface modifier created two types of crystallites: tetragonal and monoclinic crystallites.

Therefore, the nanoparticle size, structure and the amount of grafting can be controlled by adjusting the relative amounts and the order of injection of the surface modifiers into the reaction system.

Since some surface modifiers may graft preferentially over other surface modifiers, the arrangement of the surface modifiers grafted on the crystallites will depend on the order of injection of the surface modifiers.

The above results show that:
if the injection of the surface modifier is done earlier, especially before having passed ⅔^{rd} of the reaction time, the amount of surface modifier grafted over the crystallite is higher but the particle size is smaller.
Phosphonic acids have a greater effect on particle size than carboxylic acids and bromide reactive groups.
The nature of the precursor can have an influence on the crystalline structure for certain materials.

1. A continuous flow process for manufacturing surface modified metal oxide nanoparticles by supercritical solvothermal synthesis in a reaction medium flowing within a continuous flow chamber, said continuous flow chamber containing two areas:
a hydrolysis area where the reaction medium is not in supercritical state and conditions are such that nucleation and growth of metal oxide nanoparticles can be initiated; and
a supercritical area where the reaction medium is in supercritical state and the supercritical solvothermal synthesis of metal oxide nanoparticles can be performed,
said process comprising the introduction of a flow of metal oxide precursor into the continuous flow chamber at a point P1 located in the hydrolysis area or in the supercritical area, and the introduction of a flow of surface modifier into the continuous flow chamber at a point P2 located in the hydrolysis area or in the supercritical area,
wherein P2 is located downstream of P1 with respect to the flow direction.

2. The continuous flow process according to claim 1, wherein the reaction medium is an aqueous reaction medium and the solvothermal synthesis is a hydrothermal synthesis.

3. The continuous flow process according to claim 1, wherein said process further comprises the quench of the flow of surface modified metal oxide nanoparticles formed in the supercritical area at a temperature below the temperature of the supercritical area, preferably below the temperature of hydrolysis area, then the recovery of the surface modified metal oxide nanoparticles either in the form of liquid suspension or in dried form.

4. The continuous flow process according to claim 1, wherein several flows of surface modifier, identical or different, are independently introduced at the same injection point or at different injection points downstream of P1 with respect to the flow direction.

5. The continuous flow process according to claim 1, wherein the surface modifier is an organic ligand, thereby forming hybrid organic-inorganic nanoparticles.

6. The continuous flow process according to claim 1, wherein the metal oxide precursor is a metal salt, in particular an inorganic acid salt such as a nitrate, a chloride, a sulfate, an oxyhydrochloride, a phosphate, a borate, a sulfite, a fluoride or an oxyacid salt of Cu, Ba, Ca, Zn, Al, Y, Si, Sn, Zr, Ti, Sb, V, Cr, Mn, Fe, Co or Ni, or an organic acid salt such as an alkoxide, a formate, an acetate, a citrate, an oxalate or a lactate of Cu, Ba, Ca, Zn, Al, Y, Si, Sn, Zr, Ti, Sb, V, Cr, Mn, Fe, Co or Ni, more particularly a metal oxide precursor for manufacturing metal oxide nanoparticles chosen from TiO2, ZrO2, ZnO, BaTiO3, NiMoO3, NiWO3, Al2O3, Ga2O3, In2O3, SiO2, GeO2, V2O5, CeO2, CoO, α-Fe2O3, γ-Fe2O3, NiO, Co3O4, Mn3O4, γ-MnO2, Cu2O, CoFe2O4, ZnFe2O4, ZnAl2O4, Fe2CoO4, BaZrO3, BaFe12O19, LiMnO204, LiCoO2, La2O3.

7. The continuous flow process according to claim 6, wherein the metal oxide precursor is chosen from titanium (IV) isopropoxide, titanium (IV) propoxide, zirconium acetate, zirconium isopropoxide, zirconium propoxide or zirconium acetylacetonate.

8. The continuous flow process according to claim 1, wherein the concentration of the metal oxide precursor in the reaction medium is from 0.0001 mol/l to 1 mol/l, in particular from 0.001 mol/l to 0.1 mol/l, more particularly from 0.01 mol/l to 0.1 mol/l.

9. The continuous flow process according to claim 1, wherein the reaction medium is a mixture of water and ethanol or a mixture of water and isopropanol with a molar ratio water/alcohol from 1:5 to 5:2, in particular in from 1:4 to 2:1, in particular from 2:3 to 1:1, in particular around 4:5.

10. The continuous flow process according to claim 1, wherein the temperature of the reaction medium in the hydrolysis area is at least 100° C., in particular from 130° C. to 250° C., more particularly from 150° C. to 200° C.

11. The continuous flow process according to claim 1, wherein the temperature of the reaction medium in the supercritical area at least 240° C., in particular from 280° C. to 400° C., more particularly from 300° C. to 380° C.

12. The continuous flow process according to claim 1, wherein the pressure of the reaction medium in the continuous flow chamber is from 10 MPa to 30 MPa, in particular from 15 MPa to 25 MPa, more particularly around 22 MPa.

13. The continuous flow process according to claim 1, wherein the surface modifier is an organic ligand comprising an acid group, such as a carboxylic acid group, a phosphonic acid group or a sulfonic acid group, a silane group, an amine group, a thiol group, in particular a carboxylic acid group or a phosphonic acid group.

14. The continuous flow process according to claim 1, wherein the molar ratio of surface modifier/metal oxide precursor in the reaction medium is from 0.05 to 10, in particular from 0.1 to 1, more particularly from 0.15 to 0.2.

15. The continuous flow process according to claim 1, wherein both the injection points P1 and P2 are located in the hydrolysis area.

16. The continuous flow process according to claim 1, wherein the injection point P1 is located in the hydrolysis area and the injection point P2 is located in the supercritical area.

17. A device for carrying out the process according to claim 1, comprising a continuous flow chamber (1) heated with a heater (2a, 2b) which heats the continuous flow chamber (1) with an increasing gradient of temperature along the flow direction, said continuous flow chamber (1) having:
an inlet (3) for introducing the flow of metal oxide precursor into the continuous flow chamber (1) at an injection point P1,
one or several inlets (4a, 4b) for introducing the flow of surface modifier into said continuous flow heated chamber (1) at an injection point P2 which is different than and downstream of P1.

18. The device according to claim 17, wherein said continuous flow chamber (10) is a tube reactor.

19. The device according to claim 17, further comprising a filter (7) for recovering the surface modified metal oxide nanoparticles in dried from.
